(19) United States
(12) Patent Application Publication
(10) Pub. No.: US 2016/0096456 A1
(43) Pub. Date: Apr. 7, 2016

(54) REMOVABLE CALF SUPPORT FOR A CHILD SAFETY SEAT

(71) Applicant: ARTSANA USA, INC., LANCASTER, PA (US)

(72) Inventors: MICHAEL L. LONGENECKER, LANCASTER, PA (US); DAWN JOYCE LONGENECKER, LONGENECKER, PA (US)

(21) Appl. No.: 14/876,599

(22) Filed: Oct. 6, 2015

Related U.S. Application Data
(60) Provisional application No. 62/060,912, filed on Oct. 7, 2014.

(51) Int. Cl. B60N 2/44; B60N 2/28

(52) U.S. Cl. CPC B60N 2/4495; B60N 2/28

(57) ABSTRACT

A selectively installable calf support having a seat portion for overlay on the lower seating surface of a child safety seat and a moveably connected extension portion extending forwardly therefrom that is retained in a forwardly and downwardly angled position by contact between the extension portion and the forward portion of the seating portion of the safety seat to support an occupant's legs. The extension portion may include stiffening elements to limit the amount of deflection thereof during use and a folding joint enabling the extension portion to be folded to position above and adjacent to the seat portion for storage when the seat is not occupied. Provisions to selectively secure the calf support to the safety seat may also be provided.

### CROSS-REFERENCE TO RELATED APPLICATIONS

This application claims the benefit of priority of U.S. Provisional Application 62/060,912, filed Oct. 7, 2014.

### BACKGROUND OF THE INVENTION

This invention relates generally to a footrest for a small child's safety seat and, more particularly, to an easily deployable calf support extension that may be selectively installed on the seat.

Children's car safety seats are an important part of automotive safety. Designed to secure a baby or small child, these car seats are subject to federal guidelines for proper usage and installation. More recently, safety seats have been adapted to allow use of the seat outside of a car, including handles to allow the seat and child to be carried, exterior configurations allowing the seats to rest on level surfaces, and even stroller attachments. Car seats are well-known in the related art and are provided with a variety of features that insure a child's safety and expand the utility of the seat far beyond the original objective of child safety in the event of an automobile accident.

The expanding uses of safety seats have been accompanied by an increased time span during which a particular child will use the safety seat. Safety seats manufacturers have responded with the inclusion of new features that allow users to selectively adjust the seats to fit a wider range of occupant sizes and accommodate child growth during the time the seat is used. One such feature is an extension for supporting the child's calves which typically includes complex frames and mechanisms that allow the support to be folded out of the way when use of the support is not desired.

It would be advantageous to provide a calf support for a child safety seat that is easily and conveniently installable. Additional advantages would be realized by a calf support that could be easily removed from the safety seat or conveniently repositioned when not in use.

### SUMMARY OF THE INVENTION

It is therefore an object of the present invention to provide a selectively installable calf support means for a child safety seat to increase child comfort while in the seat. The calf support means includes at least one selective connector means to attach the calf support to the safety seat. The connector means is easy to use and allowing rapid installation or removal of the calf support.

It is another object of this invention to provide a selectively installable calf support for a child safety seat that is easily incorporated into the design of existing safety seats. One embodiment of the calf support includes a seat portion that overlays the safety seat bottom and extends to a forward end of the seat from which extends a calf extension. A first fastener is provided to connect the calf support to the safety seat. The first fastener may be a zipper fastener.

It is a further object of the present invention to provide a calf support for a safety seat in which the calf support is constructed primarily from soft goods materials with stiffening agents, such as laminated fabrics, positioned to produce the required stiffness in the calf support. Alternatively, a framework comprising rigid elements may be used to define the overall shape of the calf support and/or to aid in the attachment to the safety seat.

It is a further object of the present invention to provide an easily installable calf support means for a child safety seat that is durable in construction, inexpensive of manufacture, carefree of maintenance, easily assembled, and simple and effective to use. The calf support is preferably outwardly constructed in fabrics generally matching the fabrics covering the safety seat so that cost, appearance, and durability will generally match that of the safety seat to which it is attached.

These and other objects are achieved in accordance with a selectively installable calf support having a seat portion for overlay on the lower seating surface of a child safety seat and a moveably connected extension portion extending forwardly therefrom that is retained in a forwardly and downwardly angled position by contact between the extension portion and the forward portion of the seating portion of the safety seat to support an occupant's legs. The extension portion may include stiffening elements to limit the amount of deflection thereof during use and a folding joint enabling the extension portion to be folded to position above and adjacent to the seat portion for storage when the seat is not occupied. Provisions to selectively secure the calf support to the safety seat may also be provided.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a front perspective view of a child safety seat showing a first embodiment of the instant invention detached from the safety seat;

FIG. 2 shows the safety seat of FIG. 1 wherein the first embodiment of a calf support is attached to the safety seat for use;

FIG. 3 is partial side view of the calf support of FIGS. 1 and 2;

FIG. 4 is a view of the calf support showing the calf extension in a raised position;

FIG. 5 is a front view of the safety seat showing the calf support in position and oriented as shown in FIG. 4;

FIG. 6 is a view of the bottom side of the safety seat showing attachment of the calf support to the safety seat;

FIG. 7 is a view of the underside of one embodiment of the seat portion of the calf support of the instant invention;

FIG. 8 is a front view of the safety seat with the calf support removed; and

FIG. 9 shows the safety seat and invention of FIG. 2 with a child positioned in the seat.

### DESCRIPTION OF THE PREFERRED EMBODIMENT(S)

Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “up” or “down,” or “top” or “bottom” are used as a matter of mere convenience, and are determined as the safety seat would normally be positioned for use when occupied by a child. Furthermore, the various components shown or described herein for any specific application of this invention can be varied or altered as anticipated by this invention and the practice of a specific application of any element may already be widely known or used in the art by persons skilled in the art and each will likewise not therefore be discussed in significant detail. When referring to the figures, like parts are numbered the same in all of the figures.

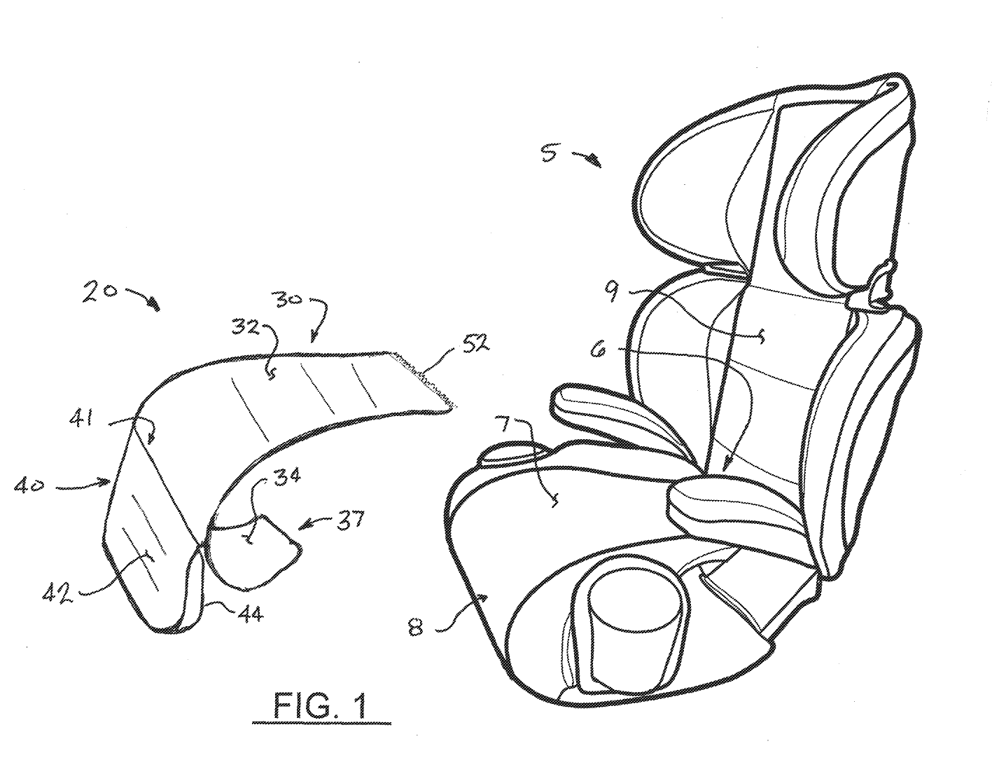

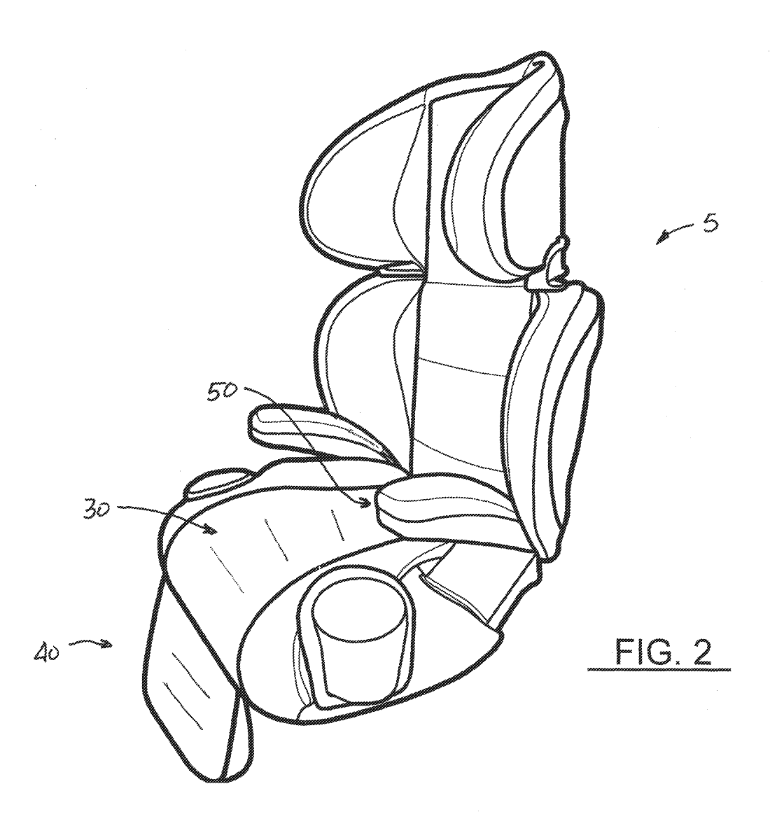

Referring to the figures and in particular to FIGS. 1, and 2 wherein there is shown a child safety seat 5 of the type on which the present invention finds utility. Safety seats are well known in the art and conventionally comprise a rigid shell or frame over which is placed padding and cover (referred to as soft goods) to improve aesthetics and occupant comfort. The safety seat includes a bottom seating surface 7 and a back rest 9 to support a child. The forward portion of the bottom seating surface 7 is curved generally downwardly in a non-coplanar arrangement with the bottom pad to define a forward roll portion 8 of the bottom seating surface. Lap belts and shoulder straps (not shown) are typically included to allow a child occupant to be securely restrained in the seat, such as for use in a vehicle. A calf support 20 embodying the present invention is shown detached from the safety seat 5 in FIG. 1 and connected for use in FIG. 2. As used herein, references to various aspects of the safety seat 5 treat the soft goods and the supporting seat shell synonymously unless otherwise noted.

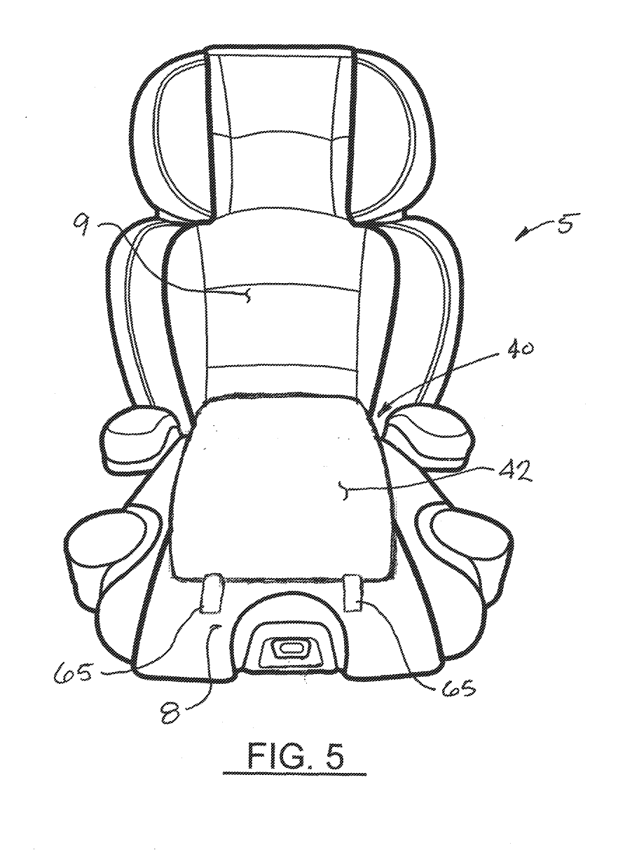

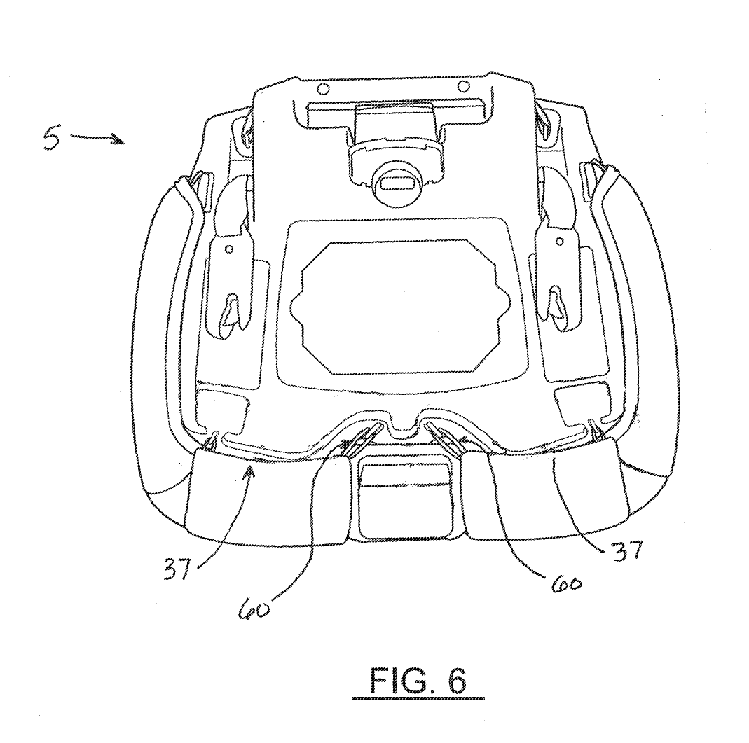

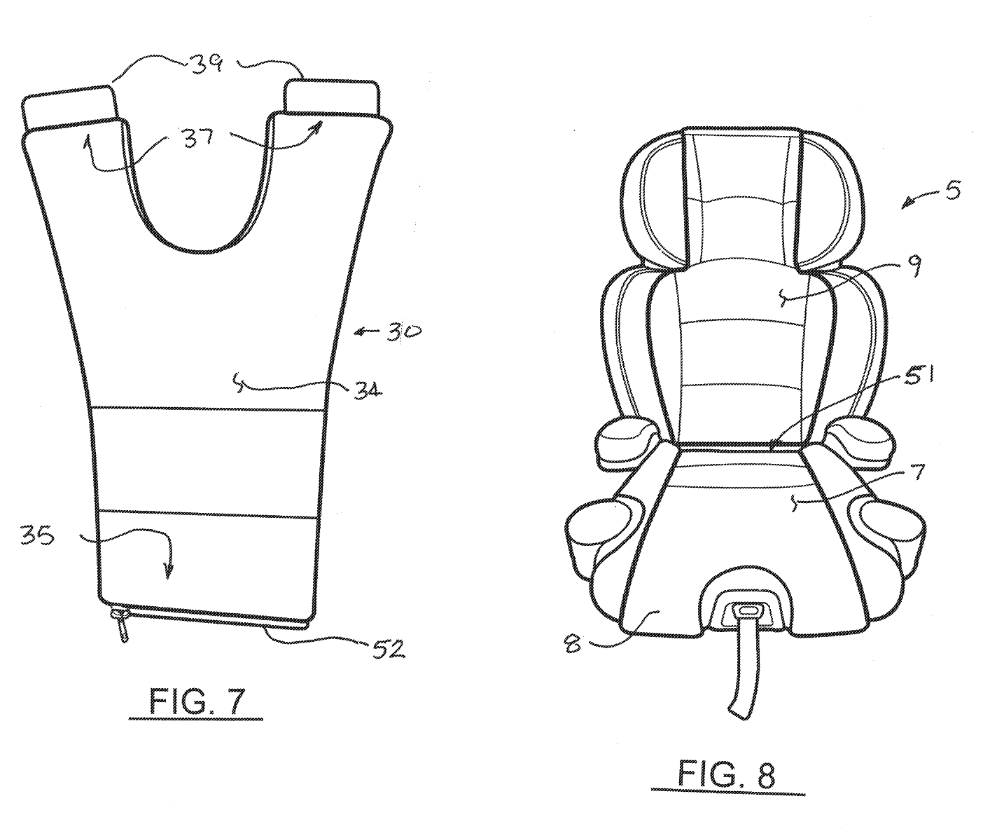

Referring to FIGS. 1 through 8, the calf support includes a seat portion 30 with an upper face 32 and a lower face 34 configured to overlay the bottom seating surface 7 of the safety seat. The seat portion 30 further includes generally opposing and spaced apart rearward 35 and forward ends 37. When installed in a safety seat, the seat portion 30 extends forwardly from the rearward end 35 along the seating surface 7 toward the forward end 37. The rearward and forward ends each include provisions to secure the seat portion 30 to the safety seat 5.

The seat portion 30 is operably secured to the safety seat 5 by first and second fasteners 50, 60, respectively. In the embodiment illustrated, the first fastener may comprise a zipper fastener having a first portion 51 connected to the safety seat 5 and a second portion 52 connected to the rearward end 35 of the seat portion 30. Other types of fasteners may be used for first fastener 50, including but not limited to snaps, buttons, and hook-and-loop fasteners. The first fastener 50 is preferably positioned on the bottom seating surface 7 of the seat in a location so as not to be uncomfortable for the child. As can be seen from the figures, the first fastener 50 is located at the junction 6 of the bottom seat surface 7 and the back rest 9 so that the child is not sitting in direct contact with the fastener 50 when the calf support 20 is installed. Similarly, with the calf support removed, the location is selected to avoid direct contact between the child occupant and the first portion 51. The first fastener 50 may be attached directly to the safety seat 5 shell or, preferably may be attached to soft goods covering the safety seat shell. The attachment of soft goods to the safety seat shell may require reinforcement proximate to the first fastener to provide a secure anchorage for the first fastener 50 when connecting to the soft goods. A flap or the like may be provided to cover the first fastener 50 and separate the child from direct contact with the first fastener 50.

One or more second fasteners 60 may be provided to secure the forward end 37 of the seat portion 30 to the safety seat 5. The forward end 37 preferably extends sufficiently to permit it to wrap around the roll portion 8 of the seating surface. The forward end 37 may further comprise one or more extensions 39 that are insertable between the safety seat 5 shell and soft goods to retain the seat portion in position against the lower seating surface 7. Receptacles may be provided in the seat shell to receive the extensions 39 to better retain the forward end 37 secured to the safety seat 5. The second fasteners 60 may comprise comprising loops, straps, buttons, zippers, or hook and loop fasteners to secure the forward end 37 to the safety seat 5.

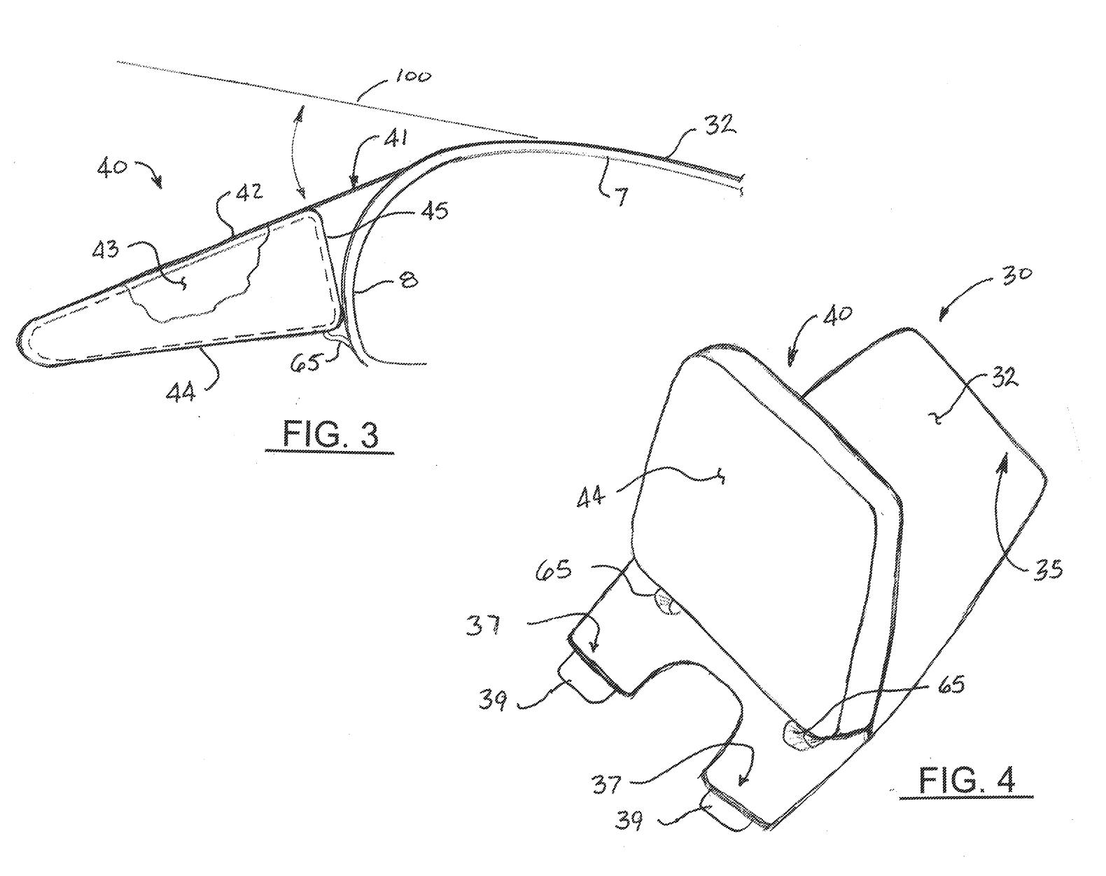

A calf extension 40 is connected to the seat portion 30. The calf extension 40 extends forwardly from the seat portion 30 from the lower seating surface 7 and is angled generally downwardly from the lower seating surface 7 when installed for occupancy by a child. As best illustrated in FIG. 3, the downwardly angled orientation of the calf extension 40 generally ranges between being co-planar with the seating surface 7 to extending perpendicularly downward from the plane 100 of the lower seating surface, with a preferable angle ranging between fifteen and sixty degrees. A flexible connection 41 connects the calf extension 40 to the seat portion 30 in a manner enabling folding movement of the calf extension 40 relative to the seat portion 30. Flexible connection 41 is preferably formed of soft goods comprising the calf support 20 that is sufficiently flexible to permit folding of the seat portion 30 relative to the calf extension 40. Normal flexure of conventional soft goods coverings permits limited displacement of the seat portion 30 allowing limited fore-aft movement of the flexible connection 41 which enables the angular deflection of the calf extension 40 to conform to specific vehicle installations.

The calf extension 40 includes an upper surface 42 and a lower surface 44 that are spaced apart to define an internal compartment 49 in which may be inserted a stiffener insert 43 to stiffen the calf extension 40. The upper and lower surfaces 42, 44 may be generally parallel or they may non-parallel to create a wedge-shaped calf extension structure when viewed from the side. A portion of the periheral ends of the upper and lower surfaces 42, 44 may be joined by an end face 45 which is positioned adjacent to the flexible connection 41. The end face 45 may be reinforced to maintain a predetermined separation distance between the upper and lower surfaces 42, 44 in the area adjacent to the flexible connection 41 or the separation between the upper and lower surfaces 42, 44 may be established by the configuration of stiffener insert 43.

As normally positioned, the calf support 20 is partially supported by the bottom seating surface 7 of the seat with the lower face 34 resting in contact therewith. The lower surface 44 of the calf extension 40 may partially rest upon the seat of a vehicle in which the safety seat 5 is installed for support. The calf extension 40 is preferably supported by contact between the end face 45 and the seat portion 30 adjacent to the roll portion 8 of the lower seating surface 7 when the calf support 20 is positioned for use. It is preferable that the distance between the rearward end 35 and the flexible connection 41 be configured consistently with the length of the lower seating surface 7 so that the flexible connection 41 and the end face 45 are positioned in adjacent proximity to the roll portion 8 of the seating surface. The end face 45 is limited in movement by the roll portion 8 which, with the positioning of the flexible connection 41, limits the extent of downward movement of the calf extension 40 in relation to the safety seat 5 and allows the downward angle to be established generally consistently.

The calf extension 40 may be stiffened to retain its general configuration by a rigid frame in metal or plastic, or through the use of soft goods that are less pliable than the materials used in conventional coverings for safety seat soft goods and thus may be fashioned into relatively stiff configurations. The calf extension 40 preferably includes an internal compartment 49 configured to receive a stiffener insert 43. A rigid frame may be incorporated into the calf extension 40 or it may be extensible from the base of the safety seat 5. It is preferred to avoid a rigid metal or plastic frame which prevents folding of the calf support 20 as such constructions generally increase the cost and complexity of the seat and calf support assembly. In one embodiment, the stiffener insert 43 comprises generally rigid material, such as a polystyrene foam, insert to provide structure to the calf extension. Other materials including open or closed-cell foams, batting, laminated fabrics, and any other of a number of well-known means to increase the stiffness of fabric materials typically used in child safety seats may be used to increase the bending resistance of the calf extension 40. Padding may be provide internally adjacent to the upper surface 42 to increase occupant comfort.

It is preferable to limit the folding movement of the calf extension 40 relative to the safety seat 5 so that the calf extension 40 normally extends forwardly and downwardly from the seating surface 7. One or more retainers 65 may be provided to limit upward folding movement of the calf extension 40, preferably to prevent the calf extension from being folded over into adjacent contact with the upper surface 32 of the seat portion 30. In this manner, the calf extension 40 may be quickly folded to an upward projection to permit easier movement of the safety seat, such as removal or installation into a vehicle, and then permitted to return to its normal downward projection by gravity or with a gentle nudge by a user. The retainers preferably extend from an area of the seat portion 30 between the flexible connection 41 and the forward end 37 and the end wall 45. In one embodiment, an opening in the soft goods covering the calf extension 40 provides access to the internal compartment 49 and apertures are provided in the soft goods adjacent to the opening through which the retainers may pass to limit the size of the opening and retain the internal stiffener 43 contained within the internal compartment 49. The retainers 65 may be in the form of straps, either elastic or generally inelastic, and are preferably configured with hook and loop closures to permit selective access to the internal compartment 49.

Storage and movement of the car seat 5 with the calf support 20 attached is enhanced by the inclusion of the flexible connection 41 which allows the calf extension 40 to be folded upwardly to reduce the overall length of the safety seat 5. This folding capability is also beneficial when storing the calf support 20 when it is not in use and detached from the safety seat by reducing the overall dimension of the calf support 20.

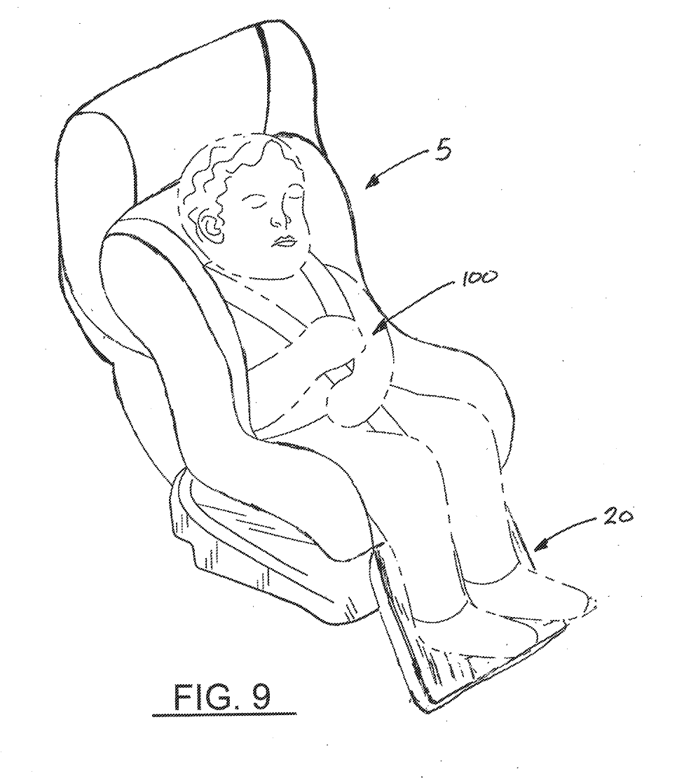

Use of the calf support 20 is shown in FIG. 9 wherein child 100 is shown in the seat. Calf support 20 extends the lower seating surface upon which the child rests to generally support the entire length of the child's legs and increase comfort.

Naturally, the invention is not limited to the foregoing embodiments, but it can also be modified in many ways without departing from the basic concepts. Changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. A leg support for a child safety seat, the safety seat having a lower seating surface with generally opposing forward and rearward ends and a back rest extending generally upwardly from the rearward end, the leg support comprising:
a seat portion having a first end and a generally opposing second end;
an extension portion connected to the seat portion; and
a first fastener connected to the first end configured to secure the first end to the safety seat and locate the seat portion adjacent to a lower seating surface of the safety seat, the second end being forwardly displaced from the first end;
the extension portion connection to the seat portion locating the extension portion adjacent to a forward portion of the safety seat in a manner limiting downward movement of the extension portion and maintaining the extension portion oriented in a forward and downwardly angled position from the lower seating surface.

2. The leg support of claim 1, further comprising a foldable connector attaching the extension portion to the seat portion, the foldable connector enabling angular movement between the extension portion and the seat portion.

3. The leg support of claim 2, wherein the extension portion comprises an upper surface, a lower surface spaced apart from the upper surface, and an end face spanning between the upper and lower surfaces adjacent to the folding joint, the end face contacting the seat portion as the seat portion is in adjacent contact with the forward portion of the safety seat thereby limiting downward movement of the extension portion and maintaining the extension portion oriented in a forward and downwardly angled position from the lower seating surface.

4. The leg support of claim 3, further comprising a second fastener connected to the extension portion configured for selective attachment to the seat portion, the second fastener restraining the extension portion in the forward and downwardly angled position relative to the lower seating surface, and when detached enabling the extension portion to be moved to a position above and adjacent to the seating portion.

5. The leg support apparatus of claim 4, wherein the second fastener comprises one or more straps.

6. The leg support of claim 1, wherein the first fastener is connected at the adjacent to the lower seating surface rearward end.

7. The leg support apparatus of claim 6, wherein the first fastener comprises a zipper, one or more buttons, one or more snap connectors, or a hook and loop connector.

8. The leg support apparatus of claim 1, further comprising a stiffening element reinforcing the extension portion to minimize distortion thereof.

9. The leg support apparatus of claim 8, wherein the stiffening element is a non-rigid stiffened fabric material having limited pliability from which the extension element is formed.

10. The leg support apparatus of claim 8, wherein the stiffening element is internally disposed within the extension portion.

11. A leg support for a child safety seat, the safety seat having a lower seating surface with generally opposing forward and rearward ends defining a seating surface length therebetween, a back rest extending generally upwardly from the rearward end, the forward end including a roll portion that is non co-planar with the lower seating surface, the leg support comprising:
a seat portion having a first end and a generally opposing second end;
an extension portion connected to the seat portion at a location between the first and second ends; and
a first fastener connected to the first end configured to attach the first end to the safety seat and locate the seat portion adjacent to a lower seating surface of the safety seat;
wherein the extension portion connection location is configured to position the extension portion adjacent to the roll portion of the safety seat to limit downward movement of the extension portion and maintain the extension portion oriented in a forward and downwardly angled position from the lower seating surface.

12. The leg support of claim 11, further comprising a foldable connector attaching the extension portion to the seat portion, the foldable connector enabling angular movement between the extension portion and the seat portion.

13. The leg support of claim 12, further comprising a second fastener connected to the extension portion configured for selective attachment to the safety seat forward end, the second fastener restraining the extension portion in the forward and downwardly angled position relative to the lower seating surface, and when detached enabling the extension portion to be moved to a position above the seating portion.

14. The leg support of claim 13, wherein the extension portion comprises an upper surface, a lower surface spaced apart from the upper surface, and an end face spanning between the upper and lower surfaces adjacent to the folding joint, the end face contacting the seat portion as the seat portion is in adjacent contact with the forward portion of the safety seat thereby limiting downward movement of the extension portion and maintaining the extension portion oriented in a forward and downwardly angled position from the lower seating surface.

15. The leg support apparatus of claim 14, wherein the second fastener comprises one or more straps.

16. The leg support of claim 11, wherein the first fastener is connected at the adjacent to the lower seating surface rearward end.

17. The leg support apparatus of claim 16, wherein the first fastener comprises a zipper, one or more buttons, one or more snap connectors, or a hook and loop connector.

18. The leg support apparatus of claim 11, further comprising a stiffening element reinforcing the extension portion to minimize distortion thereof.

19. The leg support apparatus of claim 18, wherein the stiffening element is a non-rigid stiffened fabric material having limited pliability from which the extension element is formed.

20. The leg support apparatus of claim 18, wherein the extension portion further comprises an interior compartment and the stiffening element is disposed therein.
